(19) United States
(12) Patent Application Publication
(10) Pub. No.: US 2023/0335836 A1
(43) Pub. Date: Oct. 19, 2023

(54) SECONDARY BATTERY

(71) Applicant: Samsung SDI Co., Ltd., Yongin-si (KR)

(72) Inventors: Dae Kyu KIM, Yongin-si (KR); Jong Jun PARK, Yongin-si (KR)

(21) Appl. No.: 18/135,578

(22) Filed: Apr. 17, 2023

(30) Foreign Application Priority Data
Apr. 15, 2022 (KR) 10-2022-0046779

(51) Int. Cl. H01M 50/14; H01M 50/103; H01M 50/15

(52) U.S. Cl. CPC H01M 50/14; H01M 50/103; H01M 50/15; H01M 10/0525

(57) ABSTRACT

A secondary battery includes: an electrode assembly; a case accommodating the electrode assembly; and a cap assembly coupled to an upper portion of the case. The cap assembly includes: a cap-up having a stress absorbing portion at an outer surface thereof and extending toward an inside of the case; a safety vent below the cap-up and having a notch; and a cap-down coupled to a lower portion of the safety vent.

### CROSS-REFERENCE TO RELATED APPLICATION

This application is based on and claims priority to Korean Patent Application No. 10-2022-0046779, filed on Apr. 15, 2022, in the Korean Intellectual Property Office, the entire disclosure of which is incorporated herein by reference.

### BACKGROUND

### 1. Field

Aspects of embodiments of the present disclosure relate to a secondary battery.

### 2. Description of the Related Art

Different from a primary battery that is not designed to be charged (or recharged), a secondary battery is a battery that is designed to be (re)charged and discharged. Low-capacity batteries are used in portable small electronic devices, such as smart phones, feature phones, tablet computers, notebook computers, digital cameras, and camcorders, while large-capacity batteries are widely used as power sources for driving motors in hybrid and electric vehicles. Lithium-ion secondary batteries can be classified as cylindrical, prismatic, or pouch-type secondary batteries based on their shape and case material or composition.

A cylindrical lithium-ion secondary battery generally includes a cylindrical electrode assembly, a cylindrical case accommodating the electrode assembly, an electrolyte injected inside the case to enable movement of lithium ions, and a cap assembly coupled to one side of the case to prevent leakage of the electrolyte and to prevent separation of the electrode assembly.

The above information disclosed in this Background section is for enhancement of understanding of the background of the present disclosure, and therefore, it may contain information that does not constitute prior art.

### SUMMARY

Embodiments of the present disclosure provide a secondary battery that avoids or prevents damage to a safety vent due to stress during a manufacturing process or during use.

A secondary battery, according to an embodiment of the present disclosure, includes: an electrode assembly; a case accommodating the electrode assembly; and a cap assembly coupled to an upper portion of the case. The cap assembly includes: a cap-up having a stress absorbing portion at an outer surface thereof and extending toward an inside of the case; a safety vent below the cap-up and having a notch; and a cap-down coupled to a lower portion of the safety vent.

The stress absorbing portion may be a recess.

The stress absorbing portion may have an arc shape extending along a circumference of the cap-up.

The stress absorbing portion may include a plurality stress absorbing portions arranged along the circumference of the cap-up and spaced apart from each other.

The safety vent may have a notch in an upper surface thereof and may be configured to rupture at an internal pressure equal to or higher than a reference pressure. The stress absorbing portion in the cap-up may be outside the notch with respect to a center of the case.

The stress absorbing portion may be in the outer surface of the cap-up and may have a smaller width at a lower portion than at an upper portion thereof.

The cap-up may have a terminal portion that upwardly convexly protrudes at the center of the cap-up, a coupling portion on an outer periphery of the terminal portion, and a connection portion that connects the terminal portion and the coupling portion to each other. The stress absorbing portion may extend along a circumference of the coupling portion.

The safety vent may be coupled to cover an end of the coupling portion and at least a portion of an upper surface of the cap-up, and the stress absorbing portion may be exposed without being covered by the safety vent.

The safety vent may be coupled to the cap-up through welding from the outside of the stress absorbing portion.

The stress absorbing portion may have a cross-sectional shape of any one of a trapezoid, a trapezoid that is downwardly recessed from a bottom of another trapezoid, a triangle, and a shape having a rounded bottom surface.

### BRIEF DESCRIPTION OF DRAWINGS

FIG. 1 is a cross-sectional view of a secondary battery according to an embodiment of the present disclosure.

FIG. 2 is an enlarged view of the part A in FIG. 1.

FIG. 3 is a plan view showing a region of a stress absorbing portion of a cap-up in a secondary battery according to an embodiment of the present disclosure.

FIGS. 4A and 4B are cross-sectional views illustrating a state in which a cap assembly is deformed when stress is applied thereto in a secondary battery according to an embodiment of the present disclosure.

FIGS. 5A to 5D are cross-sectional views illustrating configurations of a secondary battery according to other embodiments of the present disclosure.

### DETAILED DESCRIPTION

Hereinafter, embodiments of the present disclosure will be described, in detail, with reference to the accompanying drawings.

Embodiments of the present disclosure are described herein to more fully describe the present disclosure to those skilled in the art, and the following embodiments may be embodied in many different forms and neither the present disclosure nor the described embodiments should be construed as being limited to the embodiments set forth herein. Rather, these embodiments are provided so that this disclosure will be thorough and complete and will convey the aspects and features of the present disclosure to those skilled in the art.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

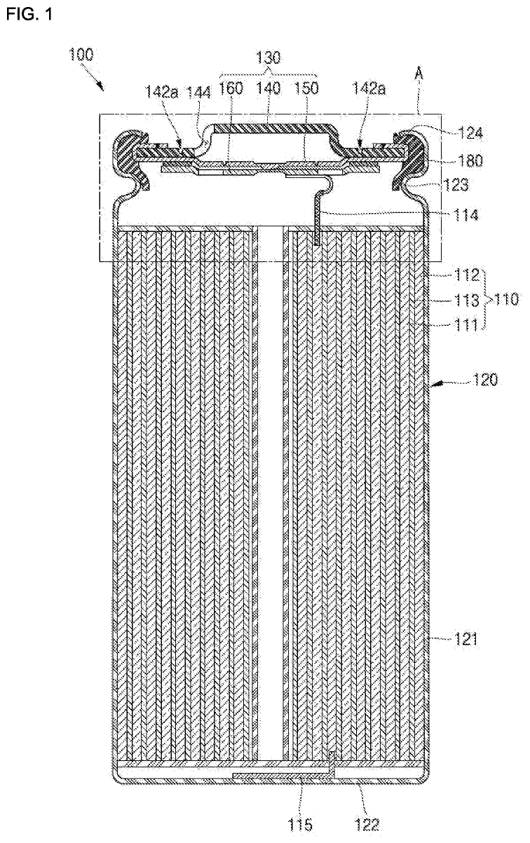

FIG. 1 is a cross-sectional view of a secondary battery according to an embodiment of the present disclosure.

Referring to FIG. 1, a secondary battery 100, according to an embodiment of the present disclosure, includes an electrode assembly 110, a case 120, a cap assembly 130, and a gasket 180.

The electrode assembly 110 includes a first electrode 111, a second electrode 112, and a separator 113 interposed between the first electrode 111 and the second electrode 112. The electrode assembly 110 may be formed by winding a laminate of the first electrode 111, the separator 113, and the second electrode 112 in a jelly-roll shape. In the illustrated embodiment, the first electrode 111 may act as a cathode, and the second electrode 112 may act as an anode, but the present disclosure is not limited thereto. A first electrode tab 114 is connected between the cap assembly 130 and the top of the electrode assembly 110, and a second electrode tab 115 connected between a bottom plate 122 of the case 120 and the bottom of the electrode assembly 110.

The first electrode 111 is formed by applying a first electrode active material, such as a transition metal oxide, to a first electrode current collector made of a metal foil, such as aluminum. A first electrode uncoated portion, to which the first electrode active material is not applied, is formed on the first electrode 111, and the first electrode tab 114 is attached to the first electrode uncoated portion. One end of the first electrode tab 114 is electrically connected to the first electrode 111, and the other end thereof protrudes upwardly from the electrode assembly 110 and is electrically connected to the cap assembly 130.

The second electrode 112 is formed by applying a second electrode active material, such as graphite or carbon, to a second electrode current collector formed of a metal foil, such as copper or nickel. A second electrode uncoated portion, to which the second electrode active material is not applied, is formed on the second electrode 112, and the second electrode tab 115 is attached to the second electrode uncoated portion. One end of the second electrode tab 115 is electrically connected to the second electrode 112, and the other end thereof protrudes downwardly from the lower portion of the electrode assembly 110 and is electrically connected to the bottom plate 122 of the case 120.

The separator 113 is positioned between the first electrode 111 and the second electrode 112 to prevent a short circuit therebetween while enabling the movement of lithium ions. The separator 113 may be made of polyethylene, polypropylene, or a composite film of polyethylene and polypropylene.

The case 120 has a side plate 121, which is a cylindrical body having a diameter (e.g., a predetermined diameter) forming a space in which the electrode assembly 110 is accommodated, and the bottom plate 122 that seals a lower portion of (e.g., a lower end of) the side plate 121. A top opening in the case 120 is open and to be sealed after inserting the electrode assembly 110 therein. In addition, a beading part (e.g., a bead) 123 for preventing movement of the electrode assembly 110 is formed at the top of the case 120. In addition, a crimping part (e.g., a crimp) 124 for fixing the cap assembly 130 and the gasket 190 is formed at the uppermost end of the case 120. The crimping part 124 has a gasket 180 interposed therein (e.g., the gasket 180 is fixed between the beading part 123 and the crimping part 124) and is formed to press the cap assembly 130 to prevent separation of the cap assembly 130 from the case 120 and leakage of the electrolyte.

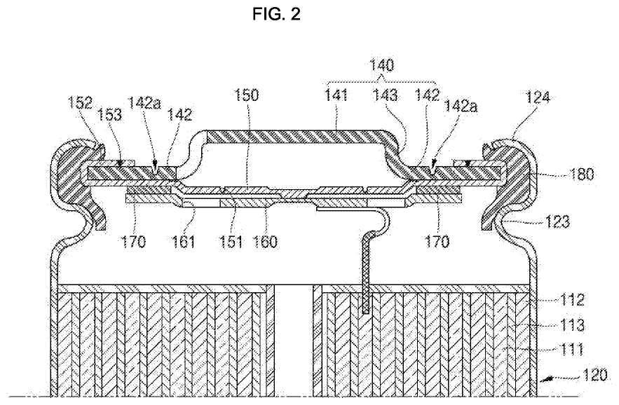

FIG. 2 is an enlarged view of the part A in FIG. 1.

Referring to FIGS. 1 and 2 together, the cap assembly 130 includes a cap-up 140, a safety vent 150, and a cap-down 160.

The cap-up 140 is a circular plate body and includes a terminal portion 141 that is upwardly convexly formed in the center of the body, a coupling portion 142 that is located on (or along) an outer periphery of the terminal portion 141, and a connection portion 143 that connects (e.g., extends between) the terminal portion 141 and the coupling portion 142.

The terminal portion 141 protrudes upwardly compared to (or from) the coupling portion 142 and acts as a terminal for electrical connection to an external circuit. The terminal portion 141 is electrically connected to the first electrode tab 114 and may act as a cathode, for example.

The coupling portion 142 is located on the outer periphery of the terminal portion 141, and the safety vent 150 is coupled to the coupling portion 142. A stress absorbing portion 142a may be formed in the coupling portion 142 at the outer side of a notch 151 in the safety vent 150 (e.g., an outer side with respect to a center of the case 120), which will be described later. The stress absorbing portion 142a may be a recess (or groove) facing the inside of the coupling portion 142. The stress absorbing portion 142a may be formed at one or more locations along the circumference of the coupling portion 142 and may be configured in the form of an arc extending along the circumference of the coupling portion 142. Thus, when stress is applied from the outside of the cap-up 140, the stress can be relieved by the deformation of the shape of the stress absorbing portion 142a. Accordingly, stress may not be transferred to the notch 151 in the safety vent 150, and operation stability can be improved. Operation of the coupling portion 142 and the stress absorbing portion 142a will be described in more detail later.

The connection portion 143 connects the terminal portion 141 and the coupling portion 142, and a gas discharge hole (e.g., a gas discharge opening) 144 is formed in the connection portion 143. A plurality of gas discharge holes 144 may be formed in the connection portion 143 to provide a path through which gas generated inside the case 120 may be discharged. In addition, some of the gas discharge holes 144 may extend to (or into) the terminal portion 141 and the coupling portion 142.

The safety vent 150 is a circular plate body corresponding to the cap-up 140 and is installed in close contact with (e.g., in direct contact with) the coupling portion 142 at the bottom of the cap-up 140. The safety vent 150 has the notch 151 so that the safety vent 150 may rupture in response to internal gas (e.g., excessive internal gas) generated inside the secondary battery 100. In addition, an edge of the safety vent 150 surrounds (e.g., extends around a periphery of) the cap-up 140 and extends to the top of the cap-up 140 (e.g., extends to the upper surface of the coupling portion 142). Here, a portion of the safety vent 150 extending upwardly from the cap-up 140 is referred to as a vent extension portion 152. In addition, the vent extension portion 152 includes a vent weld part 153. The vent weld part 153 may be formed by welding the vent extension portion 152 and the coupling portion 142 of the cap-up 140 with a laser. The vent weld part 153 may fix the safety vent 150 to the cap-up 140. When the internal pressure of the case 120 exceeds the operating pressure of the safety vent 150, the safety vent 150 rises upwardly due to gas discharged through a gas discharge hole (e.g., a gas discharge opening) 161 in the cap-down 160, and thus, the notch 151 ruptures. Then, the internal gas generated in the secondary battery 100 is discharged through the gas discharge hole 144 in the cap-up 140 to prevent the secondary battery 100 from exploding. The safety vent 150 may be made of aluminum (Al).

The cap-down 160 is a circular plate body, and the gas discharge hole 161 is formed in one side thereof. The gas discharge hole 161 discharges internal gas generated in the secondary battery 100. In addition, because the internal gas generated in the secondary battery 100 moves (or passes) through the gas discharge hole 161 to the lower surface of the safety vent 150, it pressurizes the safety vent 150, causing the safety vent 150 to rupture. The first electrode tab 114 is welded to a portion of the cap-down 160, and thus, the cap-down 160 and the first electrode tab 114 are electrically connected. In some embodiments, the first electrode tab 114 is directly welded to the lower surface of the cap-down 160.

An insulator 170 is coupled to the outer periphery of the cap-down 160. The insulator 170 is interposed between the safety vent 150 and the cap-down 160 to insulate the safety vent 150 and the cap-down 160 from each other. For example, the insulator 170 is interposed between the outer periphery of the safety vent 150 and the outer periphery of the cap-down 160. The insulator 170 may be made of a resin material, such as polyethylene (PE), polypropylene (PP), or polyethylene terephthalate (PET).

The gasket 180 is installed in the top opening of the case 120. For example, the gasket 180 is assembled in close contact between the outer periphery of the cap-up 140 and the safety vent 150 at the top opening of the case 120. The gasket 180 may be made of a resin material, such as polyethylene (PE), polypropylene (PP), or polyethylene terephthalate (PET). The gasket 180 may electrically insulate the case 120 and the cap assembly 130 from each other.

Hereinafter, the deformation operation of the stress absorbing portion of the cap-up in the secondary battery, according to an embodiment of the present disclosure, will be described in detail.

FIG. 3 is a plan view illustrating a region of a stress absorbing portion of a cap-up in a secondary battery according to an embodiment of the present disclosure.

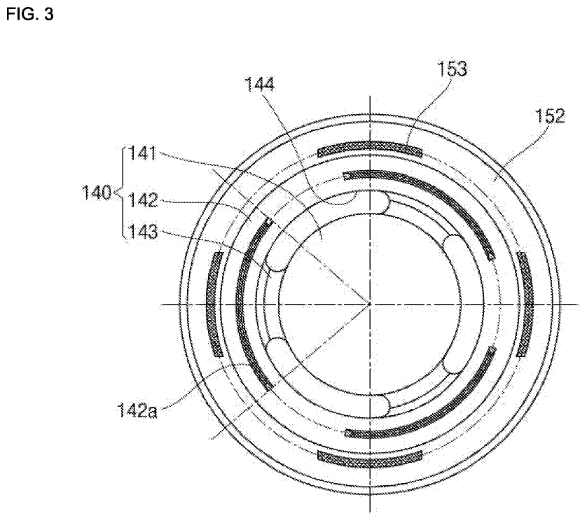

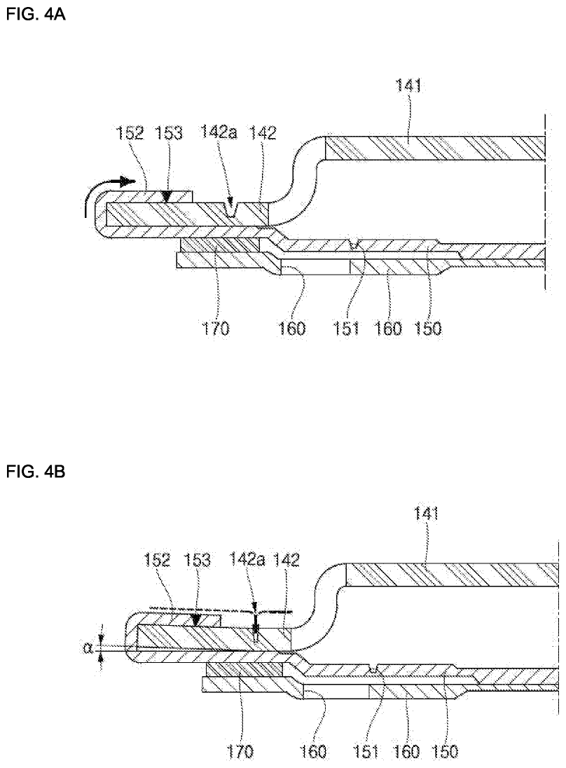

FIGS. 4A and 4B are cross-sectional views illustrating a state in which a cap assembly is deformed when stress is applied thereto in a secondary battery according to an embodiment of the present disclosure.

Referring to FIG. 3, in the secondary battery 100, according to an embodiment of the present disclosure, the stress absorbing portion 142a is formed with respect to (e.g., is formed in) the coupling portion 142 of the cap-up 140.

The stress absorbing portion 142a may have a trapezoidal cross-sectional shape and, in one embodiment, may have a shape in which the width at a lower part thereof decreases compared to the width at an upper part thereof (e.g., may have a narrowing groove shape). In addition, the stress absorbing portion 142a may be formed in an arc shape along (or corresponding to) the coupling portion 142 when viewed in a plan view with respect to the entire cap-up 140 and may be formed along a partial area of the arc. For example, as shown in FIG. 3, three stress absorbing portions 142a may be formed in an arc shape, each having the same length along the coupling portion 142 and disposed at equal intervals. However, the length, number, and spacing of the stress absorbing portion 142a is not limited thereto and can be suitably varied.

Next, referring to FIG. 4A, stress may be applied from the outside in a direction indicated by the curved arrow. The stress may be generated during the process of forming the beading part 123 or the crimping part 124 with respect to the case 120 in the manufacturing process of the secondary battery. The stress may also be generated by an external impact, etc. during use after manufacturing the secondary battery.

Referring to FIG. 4B, as described above, an operation in which the stress absorbing portion 142a in the cap-up 140 is deformed may occur. This deformation may occur in a direction such that the width of the upper portion of the stress absorbing portion 142a narrows (or closes) on the basis of (e.g., with respect to) the bottom surface of the stress absorbing portion 142a. For example, the stress absorbing portion 142a may be deformed into a shape in which the width of the upper portion of the stress absorbing portion 142a is relatively narrow.

According to this deformation, the end of the coupling portion 142 of the cap-up 140 may be lifted upwardly by an angle (e.g., by a predetermined angle) α. Through such a series of deformations, external stress is relieved, and thus, the stress may not be transferred to the notch 151 of the safety vent 150, which is coupled to the coupling portion 142. Therefore, the notch 151 in the safety vent 150 is not deformed or damaged, and the set rupture pressure of the safety vent 150 is not changed.

Hereinafter, a configuration of a secondary battery according to other embodiments of the present disclosure will be described.

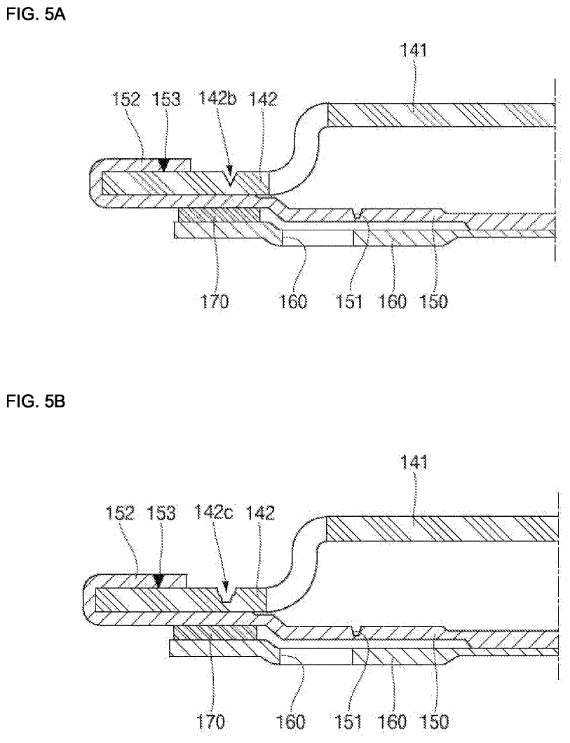

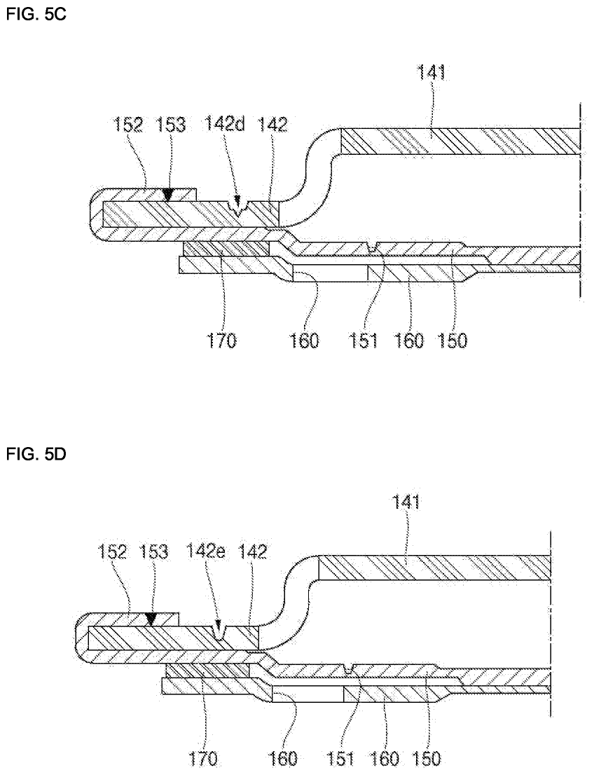

FIGS. 5A to 5D are cross-sectional views illustrating configurations of a secondary battery according to other embodiments of the present disclosure.

In FIG. 5A, the stress absorbing portion 142b has a triangular cross-sectional shape. In FIG. 5B, the stress absorbing portion 142c has a trapezoidal cross-sectional shape that becomes narrower toward the bottom and has a second trapezoidal shape formed at the center of the bottom of the larger trapezoidal shape. In FIG. 5C, the stress absorbing portion 142d has a trapezoidal cross-sectional shape that becomes narrower toward the bottom and has a triangular cross-sectional shape formed at the center of the bottom surface of the trapezoidal cross-sectional shape. In FIG. 5D, the stress absorbing portion 142e is narrower toward the bottom and has a cross-sectional shape with a rounded curved surface at the bottom.

The configurations of the stress absorbing portions shown in FIGS. 5A to 5D are examples for forming the stress absorbing portion, which may be further varied.

As described above, in the secondary battery according to embodiments of the present disclosure, by forming a stress absorbing portion outside a notch in a safety vent on an upper surface of a cap-up, the stress absorbing portion may be deformed when stress is generated to offset (or absorb) the stress and to prevent or reduce deformation or breakage of the safety vent.

While the foregoing embodiments have been described to practice the secondary battery according to the present disclosure, it should be understood that the embodiments described herein should be considered in a descriptive sense and not for purposes of limitation, and various changes in form and details may be made therein without departing from the spirit and scope of the present disclosure as defined by the following claims and their equivalents.

What is claimed is:

1. A secondary battery comprising:
an electrode assembly;
a case accommodating the electrode assembly; and
a cap assembly coupled to an upper portion of the case and comprising:
a cap-up having a stress absorbing portion at an outer surface thereof and extending toward an inside of the case;
a safety vent below the cap-up and having a notch; and
a cap-down coupled to a lower portion of the safety vent.

2. The secondary battery of claim 1, wherein the stress absorbing portion is a recess.

3. The secondary battery of claim 1, wherein the stress absorbing portion has an arc shape extending along a circumference of the cap-up.

4. The secondary battery of claim 3, wherein the stress absorbing portion comprises a plurality stress absorbing portions arranged along the circumference of the cap-up and spaced apart from each other.

5. The secondary battery of claim 1, wherein the safety vent has a notch in an upper surface thereof and configured to rupture at an internal pressure equal to or higher than a reference pressure, and
wherein the stress absorbing portion in the cap-up is outside the notch with respect to a center of the case.

6. The secondary battery of claim 1, wherein the stress absorbing portion is in the outer surface of the cap-up and has a smaller width at a lower portion than at an upper portion thereof.

7. The secondary battery of claim 1, wherein the cap-up has a terminal portion that upwardly convexly protrudes at the center of the cap-up, a coupling portion on an outer periphery of the terminal portion, and a connection portion that connects the terminal portion and the coupling portion to each other, and
wherein the stress absorbing portion extends along a circumference of the coupling portion.

8. The secondary battery of claim 7, wherein the safety vent is coupled to cover an end of the coupling portion and at least a portion of an upper surface of the cap-up, and
wherein the stress absorbing portion is exposed without being covered by the safety vent.

9. The secondary battery of claim 8, wherein the safety vent is coupled to the cap-up through welding from the outside of the stress absorbing portion.

10. The secondary battery of claim 1, wherein the stress absorbing portion has a cross-sectional shape of any one of a trapezoid, a trapezoid that is downwardly recessed from a bottom of another trapezoid, a triangle, and a shape having a rounded bottom surface.
